(19) United States
(12) Patent Application Publication
(10) Pub. No.: US 2007/0122319 A1
(43) Pub. Date: May 31, 2007

(54) Particulate filter

(76) Inventors: Herbert F. Dacosta, Peoria, IL (US); Craig F. Habeger, Chillicothe, IL (US); Michael J. Pollard, Peoria, IL (US)

Correspondence Address: CATERPILLAR INC.;100 N.E. ADAMS STREET, PATENT DEPT., PEORIA, IL, 616296490, US

(21) Appl. No.: 11/479,723

(22) Filed: Jun. 30, 2006

Related U.S. Application Data
(63) Continuation-in-part of application No. 11/289,213, filed on Nov. 29, 2005.

(51) Int. Cl. B01D 50/00; B21D 51/16; B01D 53/34

(52) U.S. Cl. 422/180; 422/177; 29/890

(57) ABSTRACT

A particulate filter and a method for reducing pollutants are provided. The particulate filter comprises at least one first piece, said first piece comprising non-linear channels, and at least one second piece adjacent to the at least one first piece. The particulate filter is configured such that either the at least one first piece or the at least one second piece comprise either sintered metal fibers or porous metallic foam. The method comprises the steps of providing a particulate filter, said filter comprising, at least one first piece, said first piece comprising non-linear channels and at least one second piece adjacent to the at least one first piece, catalyzing the particulate filter with a catalyst, passing exhaust stream through the filter, filtering at least some soot from the exhaust stream, and chemically converting at least some NOx from the exhaust stream with the catalyst.

This application is a continuation-in-part of application Ser. No. 11/289,213, filed Nov. 29, 2005, the contents of which are hereby incorporated by reference.

### U.S. GOVERNMENT RIGHTS

This invention was made with government support under the terms of DE-FC26-02AL67974 awarded by the Department of Energy. The government may have certain rights in this invention.

### Technical Field

The present disclosure relates to a particulate filter, an exhaust system of an internal combustion engine comprising a particulate filter, and a method for reducing regulated emissions from an internal combustion engine. More particularly, the present disclosure relates to a particulate filter that is configured to at least partially filter a portion of unwanted combustion byproducts that are emitted from the exhaust system of an internal or external combustion engine.

### BACKGROUND

There are millions of engines in use throughout the world. Many of these engines are internal combustion engines, including diesel and gasoline-fueled engines for automobiles. Most of these engines emit chemical species, such as nitrogen oxides (“NOx”), particulate matter (such as soot), and carbon monoxides, to name a few.

In an effort to minimize the release of these chemical species, governments within the United States and throughout the world continue to pass clean-air legislation, which regulates the amount of such chemicals that engines may lawfully emit.

One device used for reducing the emission of particulate matter is a particulate filter. A measure of the particulate filter's effectiveness is the particulate filter's filtration efficiency. The more efficient a filter is, the more effective it is at removing particulate matter from the exhaust stream.

U.S. Pat. No. 6,273,938 to Fanselow et al. (“Fanselow”) discloses a filtration media formed from a plurality of filtration layers, at least some of which include a multi-dimensional channel pattern having a plurality of continuous, tortuous channels and a multi-dimensional edge at each end of the plurality of channels formed therein. The filtration medium of Fanselow is configured as a stack with the multi-dimensional edge of the channel pattern forming a plurality of inlets open through a first face of the stack, a plurality of outlets open through a second face of the stack, and a corresponding plurality of disruptive fluid pathways passing from the inlets through the stack to the outlets.

Although Fanselow discloses a filtration media, generally, it does not disclose a filter that could effectively remove particulate matter and other combustion byproducts within the exhaust stream of an engine. The filtration media of Fanselow, for example, is manufactured from materials that could not withstand some of the high temperatures that exist within an engine's exhaust stream. Further, the microscopic structure of the filtration media of Fanselow does not lend itself to effectively filter very small soot-sized particles that are often present in engine exhaust.

The present disclosure is directed to overcoming one or more of the problems or disadvantages existing in the prior art.

### SUMMARY OF THE INVENTION

In one embodiment, a particulate filter is provided. In this embodiment, the particulate filter comprises at least one first piece, said first piece comprising non-linear channels, and at least one second piece adjacent to the at least one first piece. The filter is configured such that either the at least one first piece or the at least one second piece comprise either sintered metal fibers or porous metallic foam.

In another embodiment, a method of reducing regulated chemical species within an exhaust stream of an engine is provided. The method comprises the steps of providing a particulate filter, said filter comprising, at least one first piece, said first piece comprising non-linear channels and at least one second piece adjacent to the at least one first piece, catalyzing the particulate filter with a catalyst, passing exhaust stream through the filter, filtering at least some particulate matter from the exhaust stream, and chemically converting at least some NOx from the exhaust stream with the catalyst.

### BRIEF DESCRIPTION OF THE DRAWINGS

FIG. 1 is a perspective view of a particulate filter piece with non-linear channels;

FIG. 2 is a perspective view of two particular filter pieces with non-linear channels alternatively interposed between two flat sections;

FIG. 3 is a perspective view of exhaust gas flowing through a particular embodiment of a particulate filter;

FIG. 4 is a perspective view of the filter pieces and flat sections of FIG. 2 rolled about an axis; and

FIG. 5 is a perspective view of exhaust gas flowing through another embodiment of a particular filter.

### DETAILED DESCRIPTION

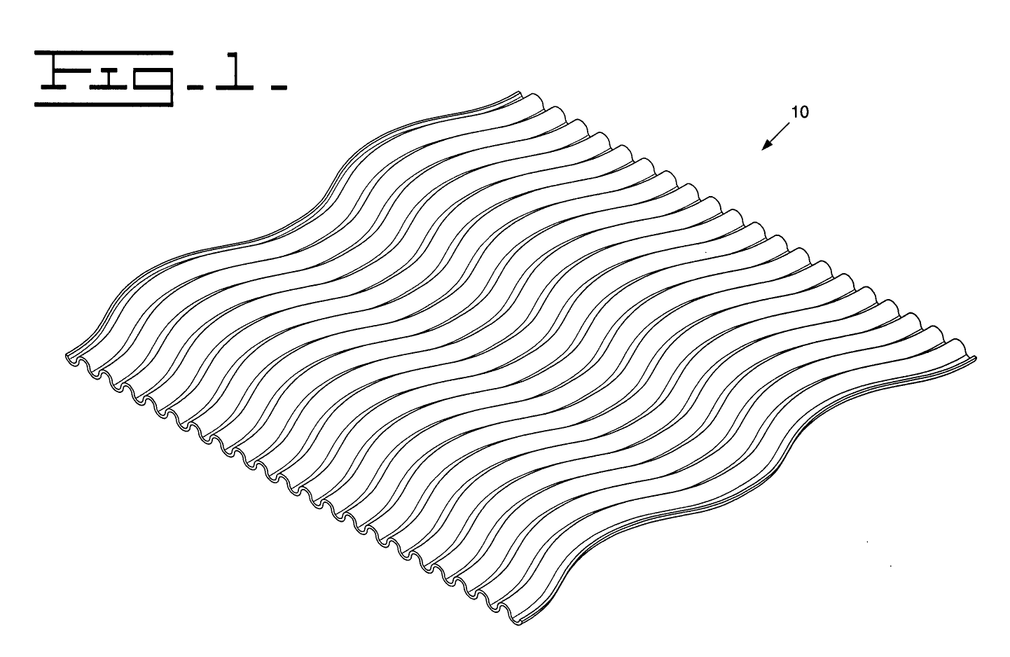

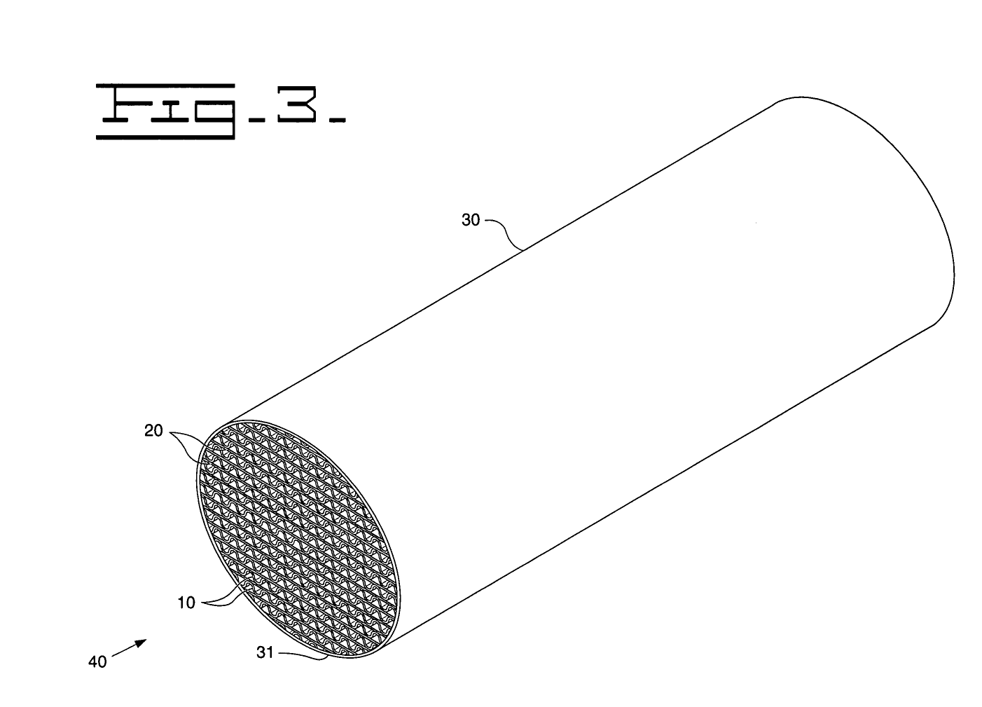

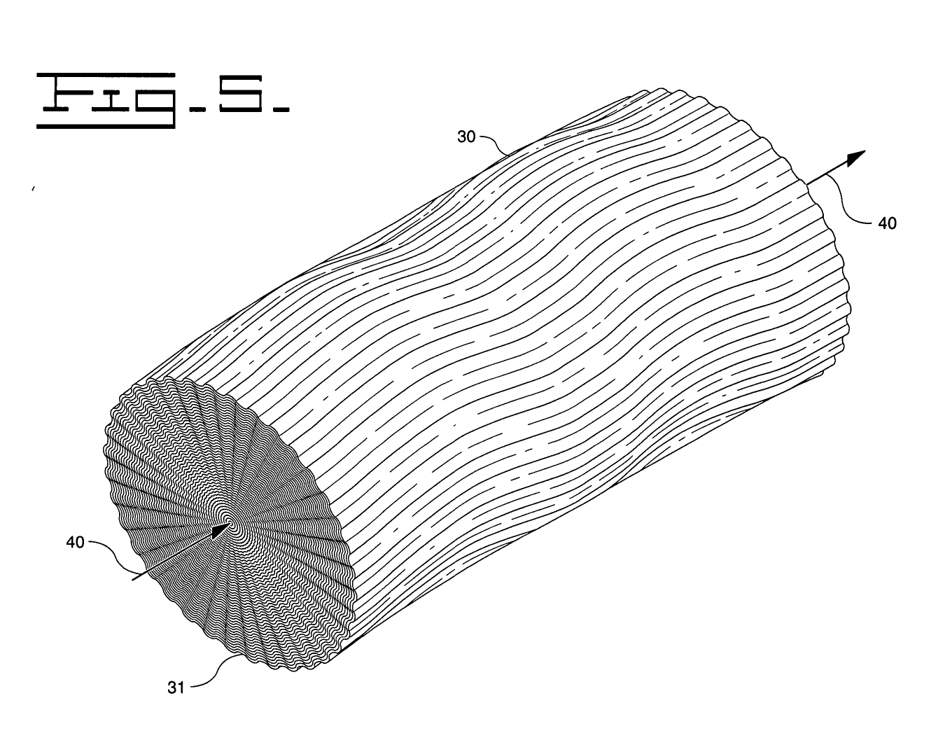

FIG. 1 is a perspective view of a filter piece 10 with non-linear channels 16. In this particular embodiment, channels 16 are sinusoidal in shape along the entire length of channels 16. Channels 16 are configured to receive fluid flow, such as exhaust gas fluid flow, when formed as part of a particulate filter 30 (shown in FIGS. 3 and 5). The non-linear nature of channels 16 promotes turbulent fluid flow, which may increase the efficiency of filtration as well as the chemical conversion by any chemical catalyst, if present.

Filter piece 10 may also be constructed of a porous material, which facilitates filtration of particulate matters. In particular, piece 10 comprises sintered metal fibers or porous metal-based foam, which provides for improved filtration efficiency. The porous nature of pieces 10 and or 20 permit the filtration of soot-sized particles of about 1 micrometer and larger.

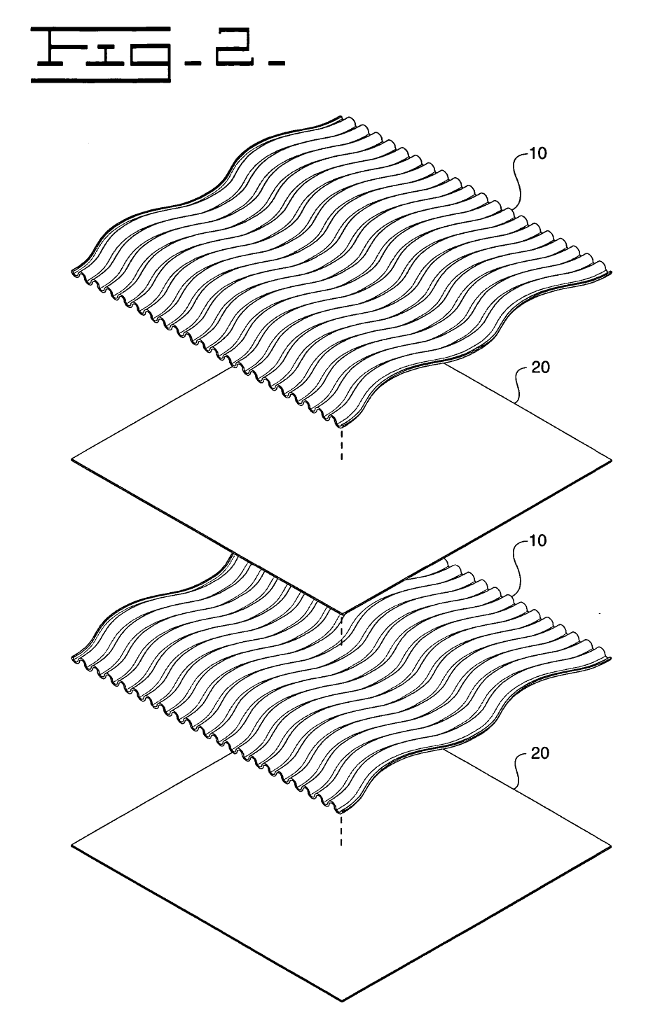

Although the depicted channels 16 in FIGS. 1 and 2 are sinusoidal, the reader should appreciate that any non-linear channel 16 may be used. For example, channels 16 may comprise sharp corners, irregular contours that are inconsistent with a typical sine wave, and any other non-linear shape, so long as turbulent flow is generated in at least part of channel 16 for at least some flow conditions.

The reader should also appreciate that the non-linear nature of channel 16 need not be present during the entire length of channel 16. Although FIGS. 1 and 2 depict a non-linear wave being present along the entire length of channel 16, the disclosed embodiments are not limited to this structure. For example, channel 16 may include non-linear waves, bends, contours, or curves, for example, for only part of the length of channel 16. During the remainder of channel 16, channel 16 may be straight.

Referring now to FIG. 2, particulate filter 30 may be manufactured by alternatively placing one or more flat pieces 20 adjacent to one or more sinusoidal pieces 10. In this particular embodiment, pieces 10 and 20 may be sandwiched together to form particulate filter 30, as depicted in FIG. 3.

In the particular embodiment of FIG. 3, pieces 10 and 20 are stacked substantially flat upon one another. As depicted in FIG. 3, before or after being stacked, pieces 10 and 20 may be cut to form a cylindrical shape for improved filtration efficiency or to facilitate packaging. Although FIG. 3 depicts pieces 10 and 20 stacked to form a cylindrical shape, the reader should appreciate that pieces 10 and 20 may be stacked to form any shape whatsoever, in order to accommodate the sometimes restrictive space limitations “under the hood” of a vehicle or for any other reason.

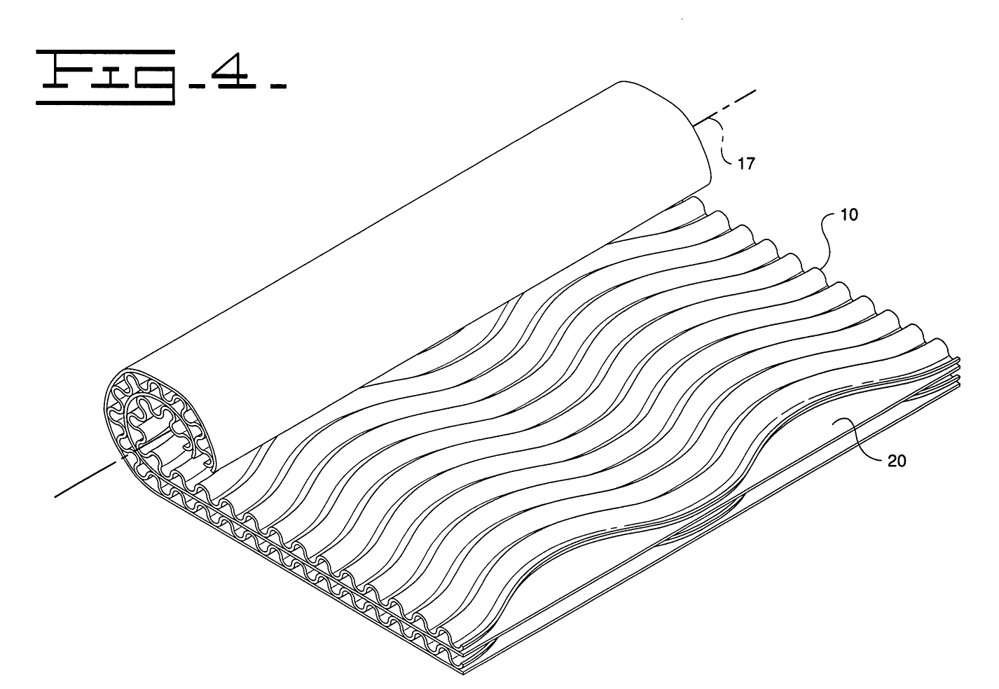

Now referring to FIGS. 4 and 5, the reader should also appreciate that pieces 10 and 20 may be rolled together about axis 17 to form particulate filter 30.

In at least one embodiment, piece 10 and or piece 20 may be composed of sintered metal fibers, such as the ones described in SAE article 2005-01-0580. Alternatively, piece 10 and or piece 20 may be composed of a porous metallic foam, such as the one described in SAE article 2006-01-1524.

As previously mentioned, in some embodiments, particulate filter 30 may be manufactured from metal fibers. Metal fibers are generally thin metal filaments having diameters that may range from about 1 to about 80 microns. Without the aid of any additives or binding components, the fibers can be sintered together to form a panel. The panels may be made of a monolayer material, where the fibers have the same fiber diameter. Alternatively, the panels may be made of a multi-layer material, which include fibers with various diameters. The panel may then be formed as either piece 10 or 20.

The metal fibers may be made from Fe—CR—Al alloy metal, such as the one described in SAE article 2005-01-0580. These Fe—CR—Al fibers can generally withstand the high temperatures present within the exhaust stream of an engine. The fibers disclosed in SAE article 2005-01-0580 have diameters ranging from about 1 to about 80 micrometers.

As previously mentioned, in other embodiments, particulate filter 30 may also be manufactured from a porous Ni-based super alloy foam, such as the one described in SAE article 2006-01-1524. The Ni-based foam is capable of withstanding high exhaust temperatures, which makes it well suited for diesel particulate filter 30 applications.

During regeneration of the particulate filter 30, the soot within the filter is oxidized, resulting in an exothermic reaction that may result in the release of large quantities of heat. As a result of this regeneration, the temperature within the filter may reach as high as 600° C. or higher. By using either the Ni-based super alloy or Fe—CR—Al alloy, the particulate filter 30 is generally not damaged during the regeneration event.

There are generally two types of regeneration: passive and active. Active regeneration occurs when heat is added to the filter by means of an external energy source. This external energy source may be a burner, which bums fuel, a post-injector, which injects fuel onto a catalyst, an electric heater, a microwave source, or any other heat source known in the art, for example. Passive regeneration—on the other hand—occurs when the filtered soot oxidizes without the addition of an external heat source. The reader should appreciate that either passive or active regeneration events may result in particulate filter 30 reaching temperatures in excess of 600° C.

Because at least some hydrocarbons within the soot will generally oxidize during varying engine load conditions, passive regeneration is present in many diesel particulate filters 30. Because the amount of regeneration required, however, generally exceeds the amount of passive regeneration present, many diesel engines are capable of regenerating particulate filters 30 actively, as well.

Because space limitations “under the hood” of a vehicle may limit the number of exhaust aftertreatment components present, the filter may be catalyzed to perform the additional function of chemically converting one or more combustion byproducts. As such, in addition to filtering soot or other particulate matters within an exhaust stream, particulate filters 30 may be coated with a chemical catalyst for chemically converting one or more of several different combustion byproducts.

In one particular embodiment of filter 30, pieces 10 and or 20 may be coated with a chemical catalyst. For example, the chemical catalyst may be a NOx catalyst or a soot oxidation catalyst. In an even further embodiment, pieces 10 and or 20 are coated with a selective catalytic reduction (“SCR”) catalyst, which in the presence of a reducing agent—such as ammonia—may convert NOx into nitrogen gas and water. Some SCR catalysts, which use ammonia or urea as a reducing agent, may comprise vanadia, tungsta deposited on titania, and or be zeolite-based. Other SCR catalysts, which may use hydrocarbons as a reductant, may comprise a transition metal deposited on metal oxides, e.g., alumina.

In another particular embodiment, pieces 10 and or 20 may be coated with a four-way catalyst. A four-way catalyst comprises a chemical for converting NOx, hydrocarbons, and carbon monoxide in addition to particulate matter. Because filter 30 also serves the function of filtering particulate matters from exhaust stream 40, this particular catalyzed filter 30 serves four functions: (1) filtering particulate matters; (2) chemically converting NOx; (3) chemically converting hydrocarbons; and (4) chemically converting carbon monoxide. Thus, the name four-way catalyst is created.

In yet another particular embodiment, filter 30 may be coated with a NOx adsorber, which together with filter 30 forms a lean-NOx trap. The most common catalyst in this group uses a precious metal, such as platinum, combined with a NOx-storage component (such as barium oxide or barium carbonate), which may be deposited on a metal oxide, e.g., alumina. In one particular embodiment, the NOx adsorber comprises platinum, barium oxide, and alumina.

There are several known catalysts that catalyze several different exhaust components that may be used along with the disclosed filters 30. One skilled in the art would understand that the disclosed embodiments are not limited to catalyzing only hydrocarbons, carbon monoxides, and NOx.

### INDUSTRIAL APPLICABILITY

The disclosed particulate filter 30 may be used in many different applications, including in the exhaust stream of an internal combustion engine. For example, particulate filter 30 may be placed in a cylindrical housing, as shown in FIG. 3, that receives exhaust gas 40 from an exhaust manifold of an engine. In such an application, exhaust gas 40 may pass through filter 30 before being emitted to the environment or may be recirculated back to the engine. As previously discussed, filter 30 may or may not be catalyzed for chemically converting combustion byproducts into more acceptable constituents.

In operation and as shown in the particular embodiment of FIGS. 3 and 5, exhaust gas 40 flows from left-to-right through particulate filter 30. As gas 40 enters the left end 31 of particulate filter 30, exhaust gas 40 may have unwanted constituents, such as hydrocarbons, carbon monoxides, and or NOx, for example.

As exhaust gas 40 enters filter 30, any particulate matter, including soot, may be collected within pieces 10 and or 20. Periodically, filter 30 may undergo a regeneration event, burning any hydrocarbons and converting it into its combustion byproducts.

Additionally, if filter 30 is catalyzed, some or all of the exhaust constituents may be fully or partially chemically converted into a more acceptable byproduct.

During this conversion, the unwanted constituents interact with the catalyst, which facilitates the chemical reaction. By providing non-linear channels 16, the flow of exhaust gas 40 through filter 30 may be more turbulent, which results in better surface interaction between exhaust gas 40 and the chemical catalyst. As a result, the conversion efficiency of the catalyst may be improved.

It will be apparent to those skilled in the art that various modifications and variations can be made with respect to the embodiments disclosed herein without departing from the scope of the disclosure. Other embodiments of the disclosed invention will be apparent to those skilled in the art from consideration of the specification and practice of the materials disclosed herein. It is intended that the specification and examples be considered as exemplary only, with a true scope of the disclosure being indicated by the following claims and their equivalents.

What is claimed is:

1. A particulate filter, comprising:
at least one first piece, said first piece comprising non-linear channels; and
at least one second piece adjacent to the at least one first piece;
such that either the at least one first piece or the at least one second piece comprise either sintered metal fibers or porous metallic foam.

2. The particulate filter of claim 1, further comprising a catalyst coated on at least part of one of the first piece or one of the second piece.

3. The particulate filter of claim 2, such that the catalyst is a selective catalytic reduction catalyst.

4. The particulate filter of claim 3, such that the catalyst is a zeolite-based catalyst.

5. The particulate filter of claim 2, such that the catalyst is a four-way catalyst configured to chemically convert NOx, hydrocarbons, and carbon monoxide.

6. The particulate filter of claim 1, further comprising a NOx adsorber coated on at least part of one of the first piece or one of the second piece.

7. The particulate filter of claim 6, such that the NOx adsorber comprises platinum, barium oxide, and alumina.

8. The particulate filter of claim 1, such that the non-linear channels are substantially sinusoidal.

9. The particulate filter of claim 1, such that the filter is configured to filter particulate matter with a diameter of about 1 micrometer and larger.

10. The particulate filter of claim 1, such that the at least one first piece or the at least one second piece comprise sintered metal fibers, such that the sintered metal fibers have a diameter from about 1 to about 80 micrometers.

11. The particulate filter of claim 10, such that the sintered metal fibers comprise an alloy comprising iron, chromium, and aluminum.

12. The particulate filter of claim 1, such that the at least one first piece or the at least one second piece comprise a porous nickel-based metallic foam.

13. The particulate filter of claim 1, such that the first and second pieces are stacked substantially flat upon one another.

14. The particulate filter of claim 1, such that the first and second pieces are rolled about an axis.

15. A method of removing soot from an engine, comprising the steps of:
providing the particulate filter of claim 1;
sending exhaust gas of an engine through the particulate filter;
filtering at least some soot from the exhaust gas with the particulate filter; and
regenerating the particulate filter to burn off at least some of the filtered soot.

16. The method of removing soot according to claim 15, such that the step of regenerating is accomplished actively.

17. A method of reducing pollutants within an exhaust stream of an engine, comprising the steps of:
providing a particulate filter, said filter comprising at least one first piece, said first piece comprising non-linear channels, and at least one second piece adjacent to the at least one first piece;
coating the particulate filter with a catalyst;
passing exhaust stream through the filter;
filtering at least some soot from the exhaust stream; and
chemically converting at least some NOx from the exhaust stream with the catalyst.

18. The method of claim 17, such that the NOx-reducing catalyst is a selective catalytic reduction catalyst.

19. The method of claim 17, further comprising the step of chemically converting hydrocarbons with the catalyst.

20. The method of claim 19, further comprising the step of chemically converting carbon monoxide with the catalyst.
